(19) United States
(12) Patent Application Publication
(10) Pub. No.: US 2014/0315679 A1
(43) Pub. Date: Oct. 23, 2014

(54) STACKED PLANETARY GEAR SET

(71) Applicant: GM GLOBAL TECHNOLOGY OPERATIONS LLC, Detroit, MI (US)

(72) Inventor: Hai Xu, Northville, MI (US)

(73) Assignee: GM Global Technology Operations LLC, Detroit, MI (US)

(21) Appl. No.: 13/867,492

(22) Filed: Apr. 22, 2013

(51) Int. Cl. F16H 57/08

(52) U.S. Cl. CPC F16H 57/08; F16H 57/082
USPC 475/331

(57) ABSTRACT

A stacked or nested planetary gear set for a transmission includes a carrier member supporting for rotation a first set of planet gears, a second set of planet gears, and a third set of planet gears, wherein each of the second set of planet gears are intermeshed with the third set of planet gears. A first sun gear is intermeshed with each of the first set of planet gears. A first ring gear is intermeshed with each of the first set of planet gears. A second sun gear is directly connected to the first ring gear and is intermeshed with each of the second set of planet gears. A second ring gear is intermeshed with each of the third set of planet gears. The stacked planetary gear set may be axially aligned or axially offset.

### FIELD

The invention relates generally to a stacked planetary gear set, and more particularly to an inner single pinion and an outer double pinion arrangement in a stacked planetary gear set.

### BACKGROUND

The statements in this section merely provide background information related to the present disclosure and may or may not constitute prior art.

In order to increase fuel efficiency and improve performance, automatic transmissions have been developed having eight, nine, and ten or more speeds. Transmissions providing eight or more speeds oftentimes have four or more planetary gear sets arranged axially. However, the need to reduce packaging size, weight, and cost of these transmissions remains essentially constant. One solution to reduce the axial length of these transmissions is to employ a stacked or nested planetary gear set. A stacked or nested planetary gear set includes an inner sun gear that meshes with a first set of planet gears, a sun/ring or intermediate gear that meshes with the first set of planet gears and an outer, second set of planet gears, and a ring gear that meshes with the second set of planet gears. The first and second set of planet gears are supported for rotation on pinion pins that are connected to a planet carrier.

While these stacked planetary gear sets are useful for their intended purpose, there is a need in the art for stacked planetary gear sets that are able to accommodate double planetary pinion designs without unnecessarily increasing axial or radial length of the transmission.

### SUMMARY

A stacked or nested planetary gear set for a transmission is provided. The planetary gear set includes a carrier member supporting for rotation a first set of planet gears, a second set of planet gears, and a third set of planet gears, wherein each of the second set of planet gears are intermeshed with the third set of planet gears. A first sun gear is intermeshed with each of the first set of planet gears. A first ring gear is intermeshed with each of the first set of planet gears. A second sun gear is directly connected to the first ring gear and is intermeshed with each of the second set of planet gears. A second ring gear is intermeshed with each of the third set of planet gears.

In one example of the planetary gear set, the second set of planet gears are disposed radially outward of the first set of planet gears and wherein the third set of planet gears are disposed radially outward of the second set of planet gears.

In another example of the planetary gear set, the first set of planet gears is disposed at intervals around the first sun gear.

In another example of the planetary gear set, the second set of planet gears is disposed at a radial offset of between 0 and 120 degrees from the first set of planet gears.

In another example of the planetary gear set, the second set of planet gears is disposed at a radial offset of 45 degrees from the first set of planet gears.

In another example of the planetary gear set, the third set of planet gears is disposed at a radial offset from the second set of planet gears.

In another example of the planetary gear set, the second set of planet gears are at a distance r1 from a rotational axis of the planetary gear set, the third set of planet gears are at a distance r2 from the rotational axis, and wherein r1 is less than r2.

In another example of the planetary gear set, the first ring gear and the second sun gear are formed on a common member, the first ring gear is disposed on an inner peripheral surface of the common member and the second sun gear is disposed on an outer peripheral surface of the common member.

In another example of the planetary gear set, the first ring gear is axially offset from the second sun gear.

In another example of the planetary gear set, the first ring gear is formed on an inner peripheral surface of a first member, the second sun gear is formed on an outer peripheral surface of a second member, and the first member is directly connected to the second member.

In another example of the planetary gear set, the first ring gear is in complete axial alignment with the second sun gear.

In another example of the planetary gear set, the first ring gear is axially offset from the second sun gear.

Further features, aspects and advantages of the present invention will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a front view of an exemplary stacked planetary gear set according to the principles of the present invention;

FIG. 2 is a cross-section of a portion of the stacked planetary gear set shown in FIG. 1;

FIG. 3A is a cross-section of a portion of the stacked planetary gear set viewed in the direction of arrow 3-3 shown in FIG. 2 according to a first embodiment;

FIG. 3B is a cross-section of a portion of the stacked planetary gear set viewed in the direction of arrow 3-3 shown in FIG. 2 according to a second embodiment;

FIG. 4A is a cross-section of a portion of the stacked planetary gear set viewed in the direction of arrow 3-3 shown in FIG. 2 according to a third embodiment; and

FIG. 4B is a cross-section of a portion of the stacked planetary gear set viewed in the direction of arrow 3-3 shown in FIG. 2 according to a fourth embodiment.

### DETAILED DESCRIPTION

The following description is merely exemplary in nature and is not intended to limit the present disclosure, application, or uses.

With reference to FIG. 1, a stacked planetary gear set according to the principles of the present invention is generally indicated by reference number 10. The stacked planetary gear set 10 includes a first sun gear 12, a planet carrier member 14, a first ring gear 16, a second sun gear 18, and a second ring gear 20. The first sun gear 12 is drivingly engaged, or intermeshed, with each of a set of inner planet gears 22. The first ring gear 16 is also drivingly engaged, or intermeshed, with each of the plurality of inner planet gears 22. The first ring gear 16 and the second sun gear 18 are connected together for common rotation, as will be described in greater detail below. The second sun gear 18 is drivingly engaged, or intermeshed, with each of a first set of outer planet gears 24A. The first set of outer planet gears 24A are each drivingly engaged, or intermeshed, with a second set of outer planet gears 24B. The second ring gear 20 is drivingly engaged, or intermeshed, with each of the plurality of outer planet gears 24B.

The first sun gear 12, the first ring gear 16, the second sun gear 18, the second ring gear 20, and the carrier member 14 may each be connected to various other components, indicated schematically by reference numbers 28A-D, respectively. These components 28A-D may include, for example shafts, countershafts, layshafts, sleeve shafts, clutches, brakes, turbine shafts, a transmission housing, or other planetary gear sets, to name but a few.

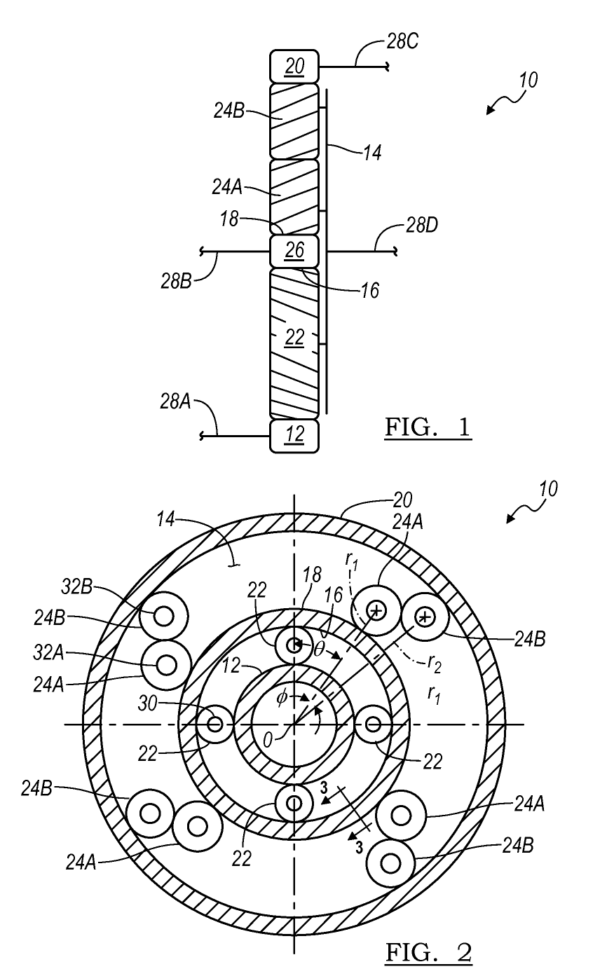

With reference to FIG. 2, the planet carrier 14 supports for a set of inner planet gear pins 30, a first set of outer planet gear pins 32A, and a second set of outer planet gear pins 32B. The set of inner planet gear pins 30 each in turn support one of the set of inner planet gears 22 for rotation thereon. The first set of outer planet gear pins 32A each support one of the first set of outer planet gears 24A for rotation thereon. The second set of outer planet gear pins 32B each support one of the second set of outer planet gears 24B for rotation thereon. While in the example provided four inner planet gears 22 and eight outer planet gears 24A-B are shown, it should be appreciated that any number of planet gears 22, 24A-B may be employed.

Measured from the axial centers of the planet gear pins, the set of inner planet gears 22 are disposed at ninety degree intervals around the inner sun gear 12. It should be appreciated that the inner planet gears 22 may be spaced at other intervals depending on various factors including tooth count of the gears and the number of planet gears. The first set of outer planet gears 24A are radially offset from the set of inner planet gears 22 at an angle “theta”. Theta varies from 0 degrees to 120 degrees, and in one example about 45 degrees is preferred. In order to reduce the radial dimensions of the stacked planetary gear set 10, the second set of outer planet gears 24B are radially offset from the first set of outer planet gears 24A at an angle “phi”. Phi varies from 0 degrees to 90 degrees. Measured from a central origin “o” located at the radial center of the stacked planetary gear set 10 to the axial centers of the planet gear pins, the first set of outer planet gears 24A are located at a radial distance r1 from the origin. The second set of outer planet gears 24B are located at a radial distance r2 from the origin. In order to reduce the radial dimensions of the stacked planetary gear set 10, r1 is less than r2 and angle “phi” is generally not equal to 0 degrees. In other words, the second set of outer planet gears 24B are offset from and partially radially outward of the first set of outer plant gears 24A.

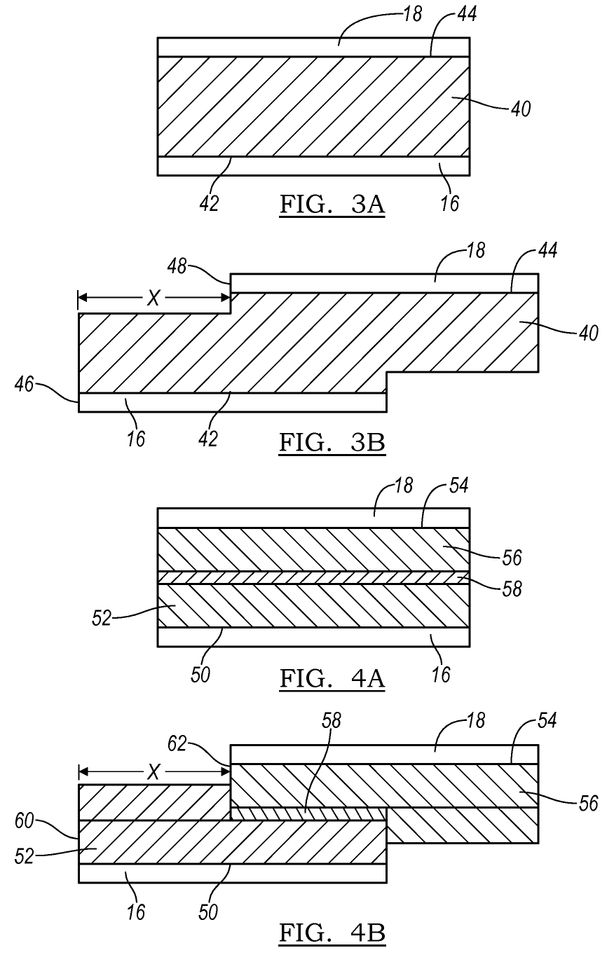

Turning to FIG. 3A, the first ring gear 16 and the second sun gear 18 are formed on a common member 40. The common construction minimizes part numbers, manufacturing and assembly processes and is preferred if heat treatment and finishing processes can be developed to achieve desired quality for both the ring gear 16 and the sun gear 18. For example, the first ring gear 16 is formed along an inner peripheral surface 42 of the member 40 and the second sun gear 18 is formed along an outer peripheral surface 44 of the member 40. The first ring gear 16 is in complete radial alignment with the second sun gear 18, i.e., no axial offset. In an alternate embodiment, the first ring gear 16 has an axial offset “X” shown in FIG. 3B. The axial offset X is measured from a first side 46 of the first ring gear 16 to a first side 48 of the second sun gear 18. The axial offset X allows the stacked planetary gear set 10 to accommodate specific transmission architecture requirements.

With reference to FIG. 4A, the first ring gear 16 and the second sun gear 18 may be separate members that are connected together to form a single, commonly rotating element. The two member construction allows separate optimal process to be utilized for the ring gear 16 and the sun gear 18. For example the first ring gear 16 is formed along an inner peripheral surface 50 of a first member 52. The second sun gear 18 is formed along an outer peripheral surface 54 of a second member 56. The first member 52 is attached to the second member 56 by a weld 58 or other connection type. The first ring gear 16 is in complete radial alignment with the second sun gear 18, i.e., no axial offset. In an alternate embodiment, the first ring gear 16 has an axial offset “X” shown in FIG. 4B. The axial offset X is measured from a first side 60 of the first member 52 to a first side 62 of the second member 56. The axial offset X allows the stacked planetary gear set 10 to accommodate specific transmission architecture requirements.

The description of the invention is merely exemplary in nature and variations that do not depart from the gist of the invention are intended to be within the scope of the invention. Such variations are not to be regarded as a departure from the spirit and scope of the invention.

What is claimed is:

1. A planetary gear set for a transmission comprising:
a first set of planet gears;
a second set of planet gears;
a third set of planet gears, wherein each of the second set of planet gears are intermeshed with the third set of planet gears;
a first sun gear intermeshed with each of the first set of planet gears;
a first ring gear intermeshed with each of the first set of planet gears;
a second sun gear directly connected to the first ring gear and intermeshed with each of the second set of planet gears; and
a second ring gear intermeshed with each of the third set of planet gears.

2. The planetary gear set of claim 1 wherein the second set of planet gears are disposed radially outward of the first set of planet gears and wherein the third set of planet gears are disposed radially outward of the second set of planet gears.

3. The planetary gear set of claim 1 wherein the first set of planet gears is disposed at intervals around the first sun gear.

4. The planetary gear set of claim 3 wherein the second set of planet gears is disposed at a radial offset of between 0 and 120 degrees from the first set of planet gears.

5. The planetary gear set of claim 4 wherein the second set of planet gears is disposed at a radial offset of 45 degrees from the first set of planet gears.

6. The planetary gear set of claim 5 wherein the third set of planet gears is disposed at a radial offset from the second set of planet gears.

7. The planetary gear set of claim 1 further comprising a carrier member that rotatably supports the first set of planet gears, the second set of planet gears, and the third set of planet gears.

8. The planetary gear set of claim 1 wherein the second set of planet gears are at a distance r1 from a rotational axis of the planetary gear set, the third set of planet gears are at a distance r2 from the rotational axis, and wherein r1 is less than r2.

9. The planetary gear set of claim 1 wherein the first ring gear and the second sun gear are formed on a common member, wherein the first ring gear is disposed on an inner peripheral surface of the common member and the second sun gear is disposed on an outer peripheral surface of the common member.

10. The planetary gear set of claim 9 wherein the first ring gear is axially offset from the second sun gear.

11. The planetary gear set of claim 1 wherein the first ring gear is formed on an inner peripheral surface of a first member, the second sun gear is formed on an outer peripheral surface of a second member, and wherein the first member is directly connected to the second member.

12. The planetary gear set of claim 11 wherein the first ring gear is in complete axial alignment with the second sun gear.

13. The planetary gear set of claim 11 wherein the first ring gear is axially offset from the second sun gear.

14. A planetary gear set for a transmission comprising:
a carrier member supporting for rotation a first set of planet gears, a second set of planet gears, and a third set of planet gears, wherein each of the second set of planet gears are intermeshed with the third set of planet gears;
a first sun gear intermeshed with each of the first set of planet gears;
a first ring gear intermeshed with each of the first set of planet gears;
a second sun gear connected to the first ring gear and intermeshed with each of the second set of planet gears, wherein the first ring gear is disposed within the second sun gear; and
a second ring gear intermeshed with each of the third set of planet gears.

15. The planetary gear set of claim 14 wherein the second sun gear axially overlaps the first ring gear.

16. The planetary gear set of claim 15 wherein the first set of planet gears and the first sun gear are disposed within and axially overlap the second sun gear.

17. The planetary gear set of claim 14 wherein the first set of planet gears is disposed at intervals around the first sun gear.

18. The planetary gear set of claim 17 wherein the second set of planet gears is disposed at a radial offset of between 10 and 90 degrees from the first set of planet gears.

19. The planetary gear set of claim 18 wherein the third set of planet gears is disposed at a radial offset from the second set of planet gears.

20. The planetary gear set of claim 14 wherein the second set of planet gears are at a distance r1 from a rotational axis of the planetary gear set, the third set of planet gears are at a distance r2 from the rotational axis, and wherein r1 is less than r2.
